(19) United States
(12) Patent Application Publication
(10) Pub. No.: US 2017/0261766 A1
(43) Pub. Date: Sep. 14, 2017

(54) CONTACT LENS WITH FLEXIBLE CENTER AND RIGID PERIPHERY

(71) Applicant: Vance M. Thompson, Sioux Falls, SD (US)

(72) Inventor: Vance M. Thompson, Sioux Falls, SD (US)

(21) Appl. No.: 15/449,211

(22) Filed: Mar. 3, 2017

Related U.S. Application Data
(60) Provisional application No. 62/307,871, filed on Mar. 14, 2016.

(51) Int. Cl. G02C 7/04; B29D 11/00; G02B 1/04

(52) U.S. Cl. CPC G02C 7/049; G02B 1/043; B29D 11/00134; B29K 2995/0065

(57) ABSTRACT

A contact lens, including a central portion formed from a flexible or soft oxygen permeable material and a peripheral portion formed from a substantially rigid material. The central portion and the peripheral portion are coupled to each other at a coupling portion.

### RELATED APPLICATION

This application claims the benefit of U.S. Provisional Application 62/307,871, filed Mar. 14, 2016, entitled “Contact Lens with Flexible Center and Rigid Periphery”, the entire content of which is incorporated herein by reference.

### FIELD OF THE INVENTION

The invention generally relates to the field of contact lenses. More particularly, the invention relates to hybrid contact lenses.

### BACKGROUND

Contact lenses having a rigid center and a flexible periphery are known. These lenses generally have been referred to as hybrid lenses. An early hybrid lens was the Precision Cosmet Saturn II lens developed decades ago and introduced in the early 1980s. Sola Barnes Hind redesigned the Saturn II lens and marketed the redesigned lens as the SoftPerm lens in the mid 1980s. More recently the SynergEyes® contact lens has become available. The SynergEyes® lens uses a high-Dk central gas permeable material and makes use of a “Hyperbond” junction between the rigid and soft portions of the lens. This bonding is said to reduce separation of the soft and rigid portions of the lens. The peripheral soft portion of the lens is formed from a nonionic, group 1 hydrophilic polymer that has a 27 percent water content and.

Numerous possible complications are known to exist with use of contact lenses on the cornea even though modern contact lenses cause far fewer complications than contact lenses of decades ago. The presence of contact lenses can lead to stasis and entrapment of the tear film which can lead to an accumulation of corneal epithelial waste products in the entrapped tear film. Corneal epithelial waste products in high enough concentrations can be toxic to the cells of the corneal epithelium. Mechanical interaction between the posterior surface of the contact lens and the corneal epithelium can lead to abrasion or distortion. Entrapment of solid objects, however tiny between the posterior surface of the contact lens and the anterior corneal epithelium can also lead to corneal epithelial abrasion. Under some circumstances, the reduction of oxygen available to the corneal epithelium by having the barrier of the contact lens between the corneal epithelium and the atmosphere can lead to health complications for the corneal epithelium as well.

There is still room for improvement in the arts of refractive correction by application of lenses to the cornea of the eye.

### SUMMARY

Existing contact lens provide many options for providing visual correction and comfortable use for contact lens users. However, there are still areas in which contact lens can be improved.

The inventions as disclosed, described and claimed herein address many of the above discussed problems and concerns.

According to an example embodiment, the invention includes a contact lens having a rigid peripheral portion and a flexible or soft central portion. A contact lens according to example embodiments of the invention presented herein generally includes a rigid peripheral portion and a flexible central portion. The rigid peripheral portion provides support and structure to the central flexible portion and may enable the use of a central flexible portion that may be substantially thinner and more flexible than that which can be used without the supporting rigid peripheral structure. It is expected that a contact lens according to the example embodiments will provide a better centration and, potentially, easier handling than conventional soft contact lenses and provide a better physiological environment for the cornea then currently existing contact lenses. The peripheral rigid portion may be formed of materials ranging from polymethylmethacrylate to silicone acrylate lens materials or fluoropolymer contact lens materials as well as silicone based contact lens materials.

The central flexible portion according to the embodiments of the invention can be formed from poly-HEMA materials as well as any material currently used in the manufacture of soft contact lenses. Further, the flexible center portion may be manufactured from any soft flexible contact lens material yet to be developed.

The overall diameter of a contact lens according to the example embodiments of the invention may range from, for example, about 6 to 18 mm. For the purposes of this application, about should be considered to include the stated distance plus or minus 0.5 mm. The diameter of the central flexible portion of a contact lens according to example embodiments of the invention may vary between, for example, 4 and 16 millimeters.

The rigid peripheral portion of the contact lens may be of a single curve or multi-curve design and have a single curvature or a plurality of peripheral curves.

The rigid peripheral portion may be of a size that fits within a diameter of the cornea, that fits proximate the limbus or that rests on the conjunctiva outside of the limbus.

Example embodiments of the invention may be produced by a process of spin casting, lathe cutting or any other process known or to be developed for the manufacture of soft or rigid contact lenses.

According to an example embodiment of the invention, the rigid periphery flexible center contact lens is formed by biocompatible optically transparent materials.

Lenses according to example embodiments of the invention may be made by a variety of different techniques. For example, techniques may include dry or frozen lathe production of the soft or flexible portion of the contact lens or of both portions of the contact lens. According to another example embodiment, a rigid material ring may be constructed followed by spin-casting or molding of the soft portion of the lens within the rigid material ring. Once the soft portion has polymerized, the joined soft and rigid portions may be removed from the mold either as a completed product or as a blank that can be subject to other processes for further polishing and processing. Accordingly to another embodiment of the invention, the soft portion may be overmolded on the rigid portion or the rigid portion may be overmolded to the soft portion. Lenses according to the invention may be processed by, for example, lathe molding or by laser machining utilizing ultraviolet or femtosecond lasers as well as other laser machining techniques.

According to another embodiment of the invention, a mold cup formed of the rigid materials may be created and soft material may be placed in the mold cup and polymerized. Thereafter, the mold cup with polymerized material can be lathe-cut or laser processed from the ensuing blank to create a lens having a rigid periphery and a soft center according to embodiments of the invention.

Contact lens materials are often described as being soft or rigid. These terms are used in this application as well. These historical terms are, by necessity, somewhat imprecise. Various terms are used to define the characteristics of materials that may be considered to be elastic, stiff, inflexible, flexible, rigid, semi-rigid or soft.

To better define the concepts of the invention applicant defines herein the following terms: stress, strain, modulus and elongation.

Stress is defined as the force per unit area required to alter the shape of a solid material. Stress equals F/A wherein F is the force applied to the material and A is a cross-sectional area of the sample to which forces applied.

Strain is a term that is used to describe the deformation that a material undergoes in the direction of the force that is applied during a testing procedure. One way of measuring strain is to apply a stretching force to a sample of the material. Strain can be measured, for example, as the percent change in length of the material relative to the sample's original length at any given point. This elongation can be represented in a formula:

Elongation=(L−L₀)/L₀×100%

wherein L is the length of the sample after force is applied and L₀ is the original length of the sample.

Modulus is a measure that describes how well a material resists deformation. Material having a high modulus is stiffer and therefore has better resistance to deformation than a material with a low modulus. Modulus can be defined as the force per unit area required to produce a deformation. This is also equal to the ratio of stress to strain.

In other words, modulus=stress/strain.

Young's modulus (E) is often cited in discussions of contact lens materials. Young's modulus is generally reported in units of megapascals (MPa). In a hypothetical ideal material that is truly elastic, Young's modulus would be a constant value and stress would be proportional to the strain applied. In reality polymeric materials are rarely truly elastic and most have both viscous and elastic properties. These materials are, therefore, referred to as viscoelastic. In the case of viscoelastic materials Young's modulus is not a constant but instead it varies with the amount of stress that is applied to the material. In these circumstances the value identified as being Young's modulus for a particular contact lens material is usually represented as the initial value which occurs at very low strains where the ratio of stress to strain is at a maximum.

The following chart lists the modulus for some example contact lens materials.

| Material | Modulus (MPa) |
|---|---|
| Lotrafilcon A | 1.5 |
| Lotrafilcon B | 1.0 |
| Balafilcon A | 1.1 |
| Senofilcon A | 0.72 |
| polyHEMA | 0.50 |
| Etafilcon A | 0.30 |
| Omafilcon A | 0.49 |
| Polymethylmethacrylate | Approximately 2000 |

According to an example embodiment of the invention, a soft material is defined as a material having a Young's modulus of less than 50 MPa. According to a further example embodiment a soft material is defined as having a Young's modulus less than 10 MPa. According to a still further example embodiment of the invention a soft material is defined as having a Young's modulus less than 5 MPa. According to yet another example embodiment of the invention, a soft material is defined as having a Young's modulus less than 2 MPa.

According to an example embodiment of the invention, a rigid contact lens material is defined as a material having a Young's modulus greater than 1000 MPa. According to a further example embodiment, a rigid contact lens material is defined as having a Young's modulus greater than 500 MPa. According to another example embodiment, a rigid contact lens material is defined as having a Young's modulus greater than 100 MPa. According to yet a further example embodiment, a rigid contact lens material is defined as having a Young's modulus greater than 50 MPa.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a plan view of a contact lens according to an example embodiment of the invention;

FIG. 2 is a plan view of a contact lens according to another example embodiment of the invention;

FIG. 3 is a schematic cross sectional view of a contact lens according to another example embodiment of the invention depicting two alternative transition portions;

FIG. 4 is a perspective view of a rigid material ring according to another example embodiment of the invention;

FIG. 5 is a schematic cross sectional view of a rigid material cup;

FIG. 6 is a schematic cross sectional view of a rigid material cup depicting concave machining;

FIG. 7 is a schematic cross sectional view of a rigid material cup depicting concave machining and convex machining;

FIG. 8 is a schematic cross sectional view of a rigid material cup depicting production of a convex hybrid lens blank according to another example embodiment;

FIG. 9 is a schematic cross sectional view of a rigid material cup depicting production of an alternative convex hybrid lens blank according to another example embodiment; and

FIG. 10 is a schematic cross sectional view of a rigid material cup and contents according to another example embodiment of the invention

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

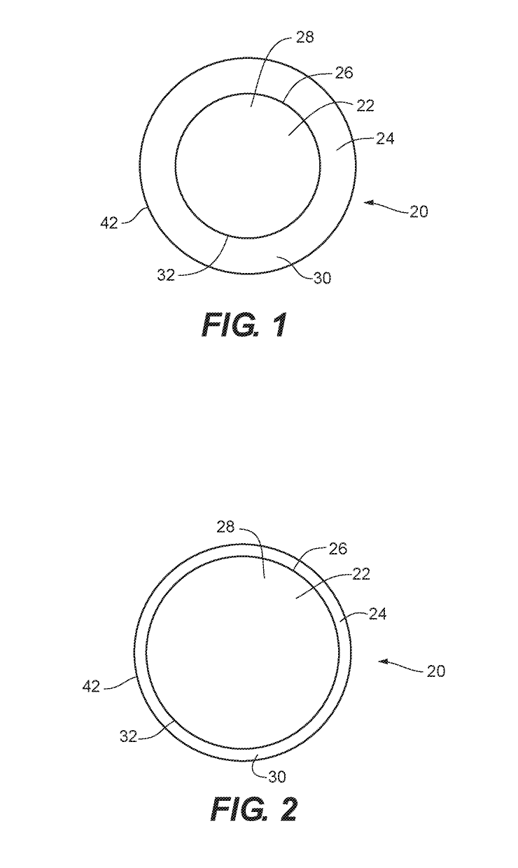

Referring to FIGS. 1 and 2, flexible center, rigid periphery contact lens 20 generally includes central portion 22, peripheral portion 24 and coupling portion 26. Central portion 22 is generally formed of flexible material 28. Peripheral portion 24 is generally formed of rigid material 30. Coupling portion 26 denotes the portion of flexible center rigid periphery contact lens 20 wherein flexible material 28 and rigid material 30 are joined or coupled.

Coupling portion 26 may, according to some example embodiments of the invention, include transition portion 32. Transition portion 32 represents that portion of the contact lens where flexible material 28 and rigid material 30, which are generally polymers, are chemically intermixed, are cross-linked or are mechanically joined.

Peripheral portion 24 may be circular in structure as depicted herein or may take on another shape. This shape may be for example oval, hexagonal, octagonal, or any other shape.

Peripheral portion 24 may present single peripheral curve 34 or multiple peripheral curves 36. Central portion 22 and peripheral portion 24 present anterior surface 38 and posterior surface 40. Posterior surface 40 is the concave surface that generally faces the eye in use. Single peripheral curve 34 or multiple peripheral curves 36 are presented on posterior surface 40 of peripheral portion 24. Peripheral portion 24 also presents peripheral edge 42. Single peripheral curve 34 or multiple peripheral curves 36 are formed as is known to those skilled in the art and may be flatter or steeper than a curvature of the posterior surface 40 of central portion 22. These structures may be formed for example by lathe cutting, molding or laser machining.

Posterior surface 40 may be spherical, aspheric or toroidal in curvature. Anterior surface 38 may also be spherical, aspheric or toroidal in shape. According to embodiments of the invention, both central portion 22 and peripheral portion 24 are highly oxygen permeable which is a benefit for the maintenance of corneal health. According to example embodiments of the invention, peripheral portion 24 may have a flatter radius of curvature than central portion 22.

Peripheral portion 24 and central portion 22 may be chemically or mechanically bonded at coupling portion 26. Thickness of central portion 22 and peripheral portion 24 will necessarily be variable due to optical considerations and may range, for example, from about 0.03 mm and about 0.5 mm. In general, positive refractive powers will have a greater central thickness while negative refractive powers will have a lesser central thickness. It is expected that flexible center rigid periphery contact lens 20 will provide excellent centration and may have value in the visual correction and treatment of corneas having irregular shape related to trauma, surgery, eye deformity or eye disease.

Either central portion 22, peripheral portion 24 or both may be modified to control rotation of flexible center rigid periphery contact lens 20. Rotation controlling modifications may include prism ballasting, periballast, the use of thin zones, double slab off, or other rotation controlling techniques known to those skilled in the art.

Flexible center, rigid periphery contact lens 20 according to an example embodiment has an overall diameter of seven to seventeen millimeters. Peripheral portion 22 according to an example embodiment may have a width of 0.5 to 5.0 millimeters. Central portion, according to an example embodiment, has a diameter of between 5 and 16 millimeters.

Peripheral portion 22 may be formed from any known or to be developed rigid contact lens polymer including but not limited to polymethyl methacrylate, fluoro-siloxane acrylate, siloxane acrylate, poly-styrene siloxane acrylate, fluorosiloxane acrylate RGP, trimethyl-siloxyl, methyl-methacrylate, ethyl-methacrylate, ethylene glycol di-methacrylate, octafluoro pentyl-methacrylate, tetra-methyldisiloxane, ethylene glycol di-methacrylate, pentafluoro phenylacrylate, 2-(trimethylsiloxyl) methacrylate, bis(2-metharyloxyphenyl) propane, N-[2-(N,N-dimethylamino)ethyl], onethacrylate, N-[2-(n,n-dimethylamino)ethyl], methacryalte, vinyl-pyrolidone, N,N-dimathacrylamide, acrylamine, hydroxyethyl methacrylate, siloxane ethylene glycol di-methacrylate, trifluoroethyl methacrylate, pentafluorostyrene, pentafluoropropyl methacrylate, unsaturated polyester; p-vinyl benzyl hexafluoroisopropyl ether, and siloxanylalkylamide.

Central portion 22 may be formed from a hydrophilic or non hydrophilic contact lens material that is flexible in nature whether now known or developed in the future. Central portion 22 may be formed from materials including but not limited to poly-2-hydroxyethyl-methacrylate; poly HEMA; hydroxyethyl acrylate; dihydroxypropyl methacrylate; polyethylaneglycol; acetoxysilane; trimethylesiloxy; ethyleneglycol-dimethacrylate; phenylethyl acrylate; and polyethylene oxide.

According to an example embodiment of the invention, central portion 22 is formed from or comprises a material having a Young's modulus of less than 50 MPa. According to a further example embodiment, central portion 22 is formed from or includes a material having a Young's modulus less than 10 MPa. According to a still further example embodiment of the invention, central portion 22 is formed from or includes a material having a Young's modulus less than 5 MPa. According to yet another example embodiment of the invention, central portion 22 is formed from or includes a material having a Young's modulus less than 2 MPa.

According to an example embodiment of the invention, peripheral portion 24 is formed from or includes a material having a Young's modulus greater than 1000 MPa. According to a further example embodiment, peripheral portion 22 is formed from or comprises a material having a Young's modulus greater than 500 MPa. According to another example embodiment, peripheral portion 24 is formed from or includes a material having a Young's modulus greater than 100 MPa. According to yet a further example embodiment, peripheral portion 24 is formed from a material or comprises a material having a Young's modulus greater than 50 MPa.

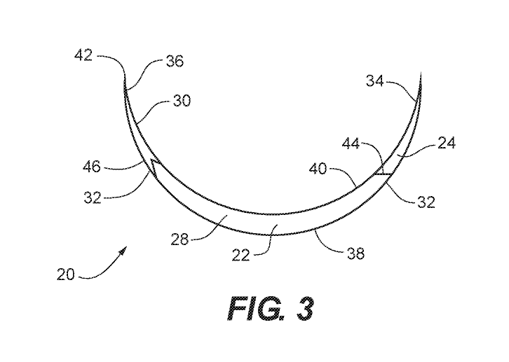

Referring now to FIG. 3, transition portion 32 may include, for example, angled juncture 44 or V-shaped juncture 46. Both angled juncture 44 and V-shaped juncture 46 may be present as depicted or reversed in direction from that depicted.

Example embodiments of the invention also include a method and devices for manufacturing a flexible center rigid periphery contact lens 20.

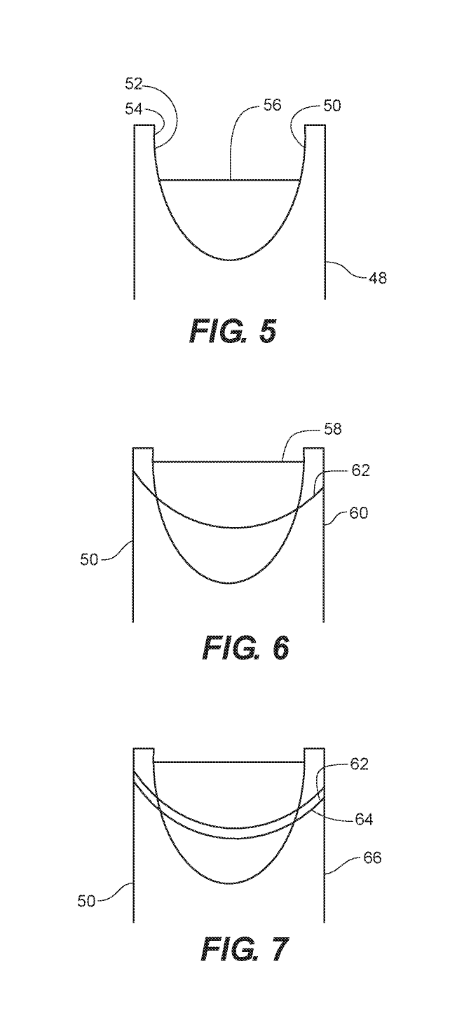

Referring to FIG. 5, according to one example manufacturing method, rigid material rod 48 formed of a rigid contact lens polymer is machined to create rigid material cup 50. Rigid material cup 50 in the depicted example embodiment presents elliptical cross-section 52. This should not be considered limiting. Cross-section 54 of rigid material cup 50 may also be cylindrical, parabolic, v-shaped, u-shaped or another shape. Still referring to FIG. 5, according to an example method, liquid flexible monomer 56 is placed into rigid material cup 50 as depicted. Liquid flexible monomer 56 may fill cup to a high level as depicted in FIG. 10 or an intermediate level as depicted in FIG. 5. Liquid flexible monomer 56 is then subject to conditions that cause polymerization of liquid flexible monomer 56 resulting in flexible polymer 58. The combination of rigid material cup 50 and flexible polymer 58 results in hybrid lens blank 60. Hybrid lens blank 60 may then be subject to machining in order to create flexible center periphery contact lens 20. Machining may be accomplished by lathe cutting, laser machining such as ablative machining or femtosecond laser machining or by CNC mechanical machining.

Referring to FIG. 6 in a first machining step, material that is located above concave surface 62 can be removed by machining thus creating concave surface 62 which may be polished as required depending upon the machining method used. Referring now to FIG. 7, material located below convex surface 54 may be removed by machining thus creating convex surface 64 which can be subject to polishing as necessary depending on the method of machining used.

Accordingly, in FIG. 7, flexible center rigid periphery contact lens 20 remains following the machining activities. The machining activities depicted in FIG. 6 results in the production of intermediate concave hybrid lens blank 66.

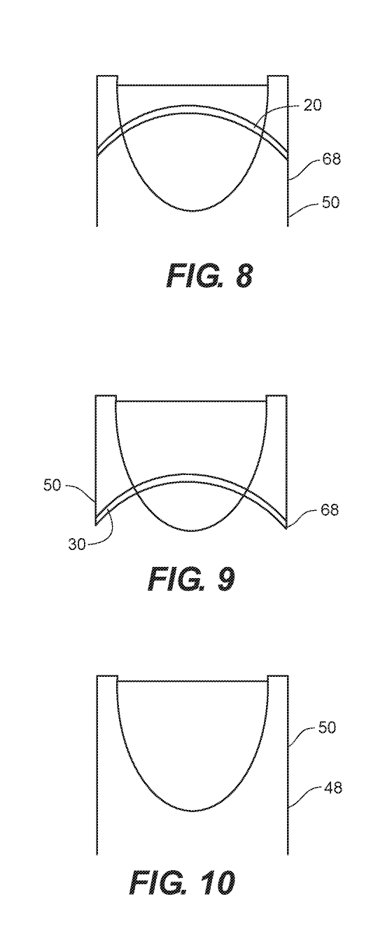

Referring now to FIG. 8, and according to an alternative embodiment of the manufacturing method, hybrid lens blank 60 is machined as depicted in FIG. 8 to produce convex hybrid lens blank 68. This occurs when material lying above convex surface 64 is removed by machining. Subsequently, material lying below concave surface 62 is removed by machining resulting in flexible center rigid periphery contact lens 20 which may be polished on concave surface 62 or convex surface 64 as necessary depending upon the machining method. Single peripheral curve 34 or multiple peripheral curves 36 may be produced during machining by known techniques.

Referring now to FIGS. 8 and 9, FIG. 8 depicts a machining scheme in which central portion 22 is larger in diameter while peripheral portion 24 is narrower in width as compared to the machining scheme in FIG. 9 wherein central portion 22 is smaller in diameter and peripheral portion 24 is greater in width as compared to FIG. 8.

As can be seen by the example embodiments depicted in FIGS. 5-10, depending upon the machining done to hybrid lens blank 64, a variety of diameters of central portion 22 may be achieved while a variety of widths of peripheral portion 24 may also be achieved. An overall diameter of flexible center rigid periphery contact lens 20 may be altered by either altering the diameter of rigid material rod 48 or reducing the diameter of flexible center rigid periphery contact lens 20 after surface machining by further machining to reduce diameter as known to those skilled in the art.

Peripheral edge 42 may be formed to many shapes by generally conventional methods of edge polishing or edge machining as known to those skilled in the art.

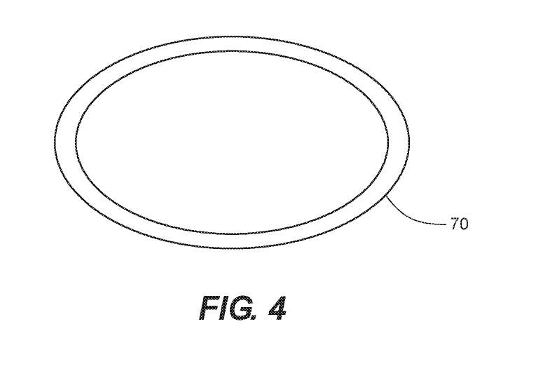

Referring now to FIG. 4, rigid material ring 70 is depicted. Rigid material ring 70 may be formed independently of central portion 22 and be used as peripheral portion 24. Rigid material ring 70 may be the basis for another manufacturing technique according to an example embodiment of the invention. According to this example embodiment, rigid material ring 70 is machined and formed by conventional methods including machining, molding or other methods known to those skilled in the art. Rigid material ring 70 may then be placed in a molding cup 72 and liquid flexible monomer 56 is placed in molding cup 72 to surround and enclose rigid material ring 70. The resulting blank with rigid material ring embedded therein can then be machined by methods as discussed herein or known to those skilled in the art to produce flexible center rigid periphery contact lens 20. Accordingly to another example embodiment, rigid material ring 70 may be placed in molding cup 72 which can then be used in a spin casting process to incorporated rigid material ring 70 into a spin cast flexible center rigid periphery contact lens 20.

In operation, flexible center rigid periphery contact lens 20 is placed on an eye by generally conventional handling and care techniques. Flexible center rigid periphery contact lens 20 may be maintained and disinfected using conventional disinfection approaches that are appropriate to the materials from which central portion 22 and peripheral portion 24 are made.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A contact lens, comprising:
a central portion formed from a flexible or soft oxygen permeable material having a first rigidity;
a peripheral portion formed from a substantially rigid material having a second rigidity;
wherein the first rigidity is greater than the second rigidity
wherein the central portion and the peripheral portion are coupled to each other at a coupling portion.

2. The contact lens as claimed in claim 1, wherein the central portion and the peripheral portion are concentric.

3. The contact lens as claimed in claim 1, further comprising a transition portion between the central portion and the peripheral portion wherein the transition portion comprises a mixture of a first polymer that forms the central portion and a second polymer that forms the peripheral portion.

4. The contact lens as claimed in claim 1, wherein the peripheral portion comprises a material selected from a group consisting of: fluoro-siloxane acrylate, siloxane acrylate, poly-stryene siloxane acrylate, fluorosilixane acrylate RGP, trimethyl-siloxyl, methyl-methacrylate, ethyl-methacrylate, ethylene glycol di-methacrylate, octafluoro pentyl-methacrylate, tetra-methyldisiloxane, ethylene glycol di-methacrylate, pentafluoro phenylacrylate, 2-(trimethylsiloxyl) methacrylate, bis(2-metharyloxyphenyl) propane, N-[2-N,N-dimethylamino)ethyl], onethacrylate, N-[2-(n,n-dimethylamino)ethyl], methacrylate, vinyl-pyrolidone, N,N-dimathacrylamide, acrylamine, hydroxyethyl methacrylate, siloxane ethylene glycol di-methacrylate, trifluoroethyl methacrylate, pentafluorostyrene, pentafluoropropyl methacrylate, unsaturated polyester; p-vinyl benzyl hexafluoroisopropyl ether, and siloxanylalkylamide

5. The contact lens as claimed in claim 1, wherein the central portion comprises a material selected from a group consisting of: poly-2-hydroxyethyl-methacrylate; poly HEMA; hydroxyethyl acrylate; dihydroxypropyl methacrylate; polyethylaneglycol; acetoxysilane; trimethylesiloxy; ethyleneglycol-dimethacrylate; phenylethyl acrylate; and polyethylene oxide.

6. The contact lens as claimed in claim 1, wherein the central portion presents a concave surface and the concave surface presents a single curvature.

7. The contact lens as claimed in claim 1, wherein the central portion presents a concave surface and the concave surface presents a several curvatures.

8. The contact lens as claimed in claim 1, wherein the peripheral portion presents a concave surface and the concave surface presents a single curvature.

9. The contact lens as claimed in claim 1, wherein the peripheral portion presents a concave surface and the concave surface presents a several curvatures.

10. The contact lens as claimed in claim 1, wherein a width of the peripheral portion comprises a distance from an outer edge of the central portion to an outer edge of the peripheral portion and the width is between 0.5 millimeters and 10 millimeters.

11. The contact lens as claimed in claim 1, wherein the coupling portion comprises a junction between the central portion and the peripheral portion and the junction, when viewed in cross section comprises a V-shaped interface between the central portion and the peripheral portion.

12. The contact lens as claimed in claim 1, wherein the coupling portion comprises a junction between the central portion and the peripheral portion and the junction, when viewed in cross section comprises an angled interface between the central portion and the peripheral portion.

13. The contact lens as claimed in claim 1, wherein the flexible or soft oxygen permeable material has a Young's modulus of less than 50 megapascals.

14. The contact lens as claimed in claim 1, wherein the flexible or soft oxygen permeable material has a Young's modulus of less than 10 megapascals.

15. The contact lens as claimed in claim 1, wherein the flexible or soft oxygen permeable material has a Young's modulus of less than 5 megapascals.

16. The contact lens as claimed in claim 1, wherein the flexible or soft oxygen permeable material has a Young's modulus of less than 5 megapascals.

17. The contact lens as claimed in claim 1, wherein the flexible or soft oxygen permeable material has a Young's modulus of less than 5 megapascals

18. The contact lens as claimed in claim 1, wherein the substantially rigid material has a Young's modulus of greater than 1000 megapascals.

19. The contact lens as claimed in claim 1, wherein the substantially rigid material has a Young's modulus of greater than 500 megapascals.

20. The contact lens as claimed in claim 1, wherein the substantially rigid material has a Young's modulus of greater than 100 megapascals.

21. The contact lens as claimed in claim 1, wherein the substantially rigid material has a Young's modulus of greater than 50 megapascals.

22. A method of manufacturing a contact lens, comprising:
forming a peripheral portion formed from a substantially rigid material;
forming a central portion formed from a flexible or soft oxygen permeable material; and
joining the central portion to the peripheral portion at a coupling portion.

23. The method of manufacturing as claimed in claim 22, further comprising forming the peripheral portion as a rigid material cup.

24. The method of manufacturing as claimed in claim 22, further comprising forming the peripheral portion as a rigid material ring.

25. The method of manufacturing as claimed in claim 23, further comprising polymerizing the central portion in place within the rigid material cup.

26. The method of manufacturing as claimed in claim 23, further comprising placing the rigid material ring in a molding cup and polymerizing the central portion in place within the molding cup.
